(19) United States
(12) Patent Application Publication
(10) Pub. No.: US 2017/0023214 A1
(43) Pub. Date: Jan. 26, 2017

(54) COMPOSITE MULTI-LAYER CIRCUIT BOARD AND MANUFACTURING METHOD THEREOF

(71) Applicant: MORRISON OPTOELECTRONICS LTD., Hsin Chu Hsien (TW)

(72) Inventors: Wei-Kuo CHENG, Taipei City (TW); Chin-Chen KUO, Hsinchu City (TW); Sheng-Wei WANG, Hsinchu City (TW)

(21) Appl. No.: 14/806,834

(22) Filed: Jul. 23, 2015

(51) Int. Cl. F21V 19/00; F21V 7/22

(52) U.S. Cl. CPC F21V 19/001; F21V 7/22; F21Y 2113/007

(57) ABSTRACT

Disclosed is a composite multi-layer circuit board and the manufacturing method thereof, on which at least two sets of circuits are formed on a ceramic substrate for supplying power to two groups of different color temperature LEDs respectively; specifically, the two sets of circuits are intertwined with each other, so that the first color temperature LED and the second color temperature LED are disposed adjacently. Also, one of the circuits is embedded in the surface of the ceramic substrate.

### BACKGROUND OF THE INVENTION

1. Field of the Invention

The present invention relates to a composite multi-layer circuit board and the manufacturing method thereof, particularly to a substrate on which two sets of circuits are disposed for supplying power to different color temperature LEDs. Specifically, one of the circuits is embedded in the surface of the substrate. Also, the first color temperature LEDs and the second color temperature LEDs are disposed adjacently, so that the overall distribution of the light color is more even and soft.

2. Description of the Related Art

The LED (light emitting diode) is a high-power light-emitting electronic product. With the increasing miniaturization of LED electronic products, heat dissipation is a major challenge for the LED circuit board.

As LED becomes more widely used, the demand for LED light color is relatively increased. The traditional single color temperature LED has been unable to meet the user's demand. Therefore, it is developed in the industry that different color temperature LEDs are disposed on a substrate, so as to enhance light color applications.

As shown in FIG. 1, a conventional approach that two color temperature LED groups are disposed on a substrate is: several LEDs in a first group of color temperature LEDs are disposed together as a first color temperature LED group 100, and several LEDs in a second group of color temperature LEDs are disposed together as a second color temperature LED group 200. The circuit of the two color temperature LED groups 100, 200 is connected to cathodes 101, 201 and anodes 102, 202 respectively to form a single loop.

However, although two groups of different color temperature LEDs that are conventionally disposed on a substrate have the respective circuit, each color temperature LED group is disposed separately. That is, the first color temperature LED group 100 is disposed on one side of the substrate, and the second color temperature LED group 200 is disposed on the opposite side of the substrate. When two different color temperature LED groups are simultaneously illuminated, the LED groups being disposed separately results in two distinct segments of light and color, likely to cause dazzling visual bias.

In addition, the low-resistance property of copper makes it an important material to connect between components. For high-density, high-power LED, however, when entering the miniaturization stage, the metal wire with a smaller width may result in higher resistance, heat increases, and decrease the uniformity of the LED light. The conventional LTCC and HTCC technology use a thick film printing technology for wire manufacturing. The thick film printing technology itself is limited to the screen tension problem, and the wire surface may be rough, likely to cause the phenomenon such as alignment incorrectness and too large progressive tolerance. Even through DBC produces metal wires through a lithography process, the process capability is limited. The copper thickness may only be limited to 150-300 μm, and the resolution of metal wires is merely 150-300 μm (aspect ratio of 1:1 normally).

### SUMMARY OF THE INVENTION

In view of the aforementioned shortcomings in the art, the inventor studied a variety of light emitting diode (LED) methods based on manufacturing experiences and skills accumulated, and finally developed and designed a new composite multi-layer circuit board and a manufacturing method thereof according to the present invention, after continuous research, experiments and improvement, to solve the aforementioned shortcomings in the prior art.

A composite multi-layer circuit board and a manufacturing method thereof according to the present invention uses various techniques including micro-groove etching inside the substrate, 3D metalized copper wire and intertwined copper wire process to enable different color temperature circuit LEDs to be disposed adjacently.

According to the composite multi-layer circuit board and the manufacturing method thereof in the present invention, on which the front intertwined copper wire is embedded into the interior of the substrate surface, and the rear part of the wire is produced using a better insulation and high reflection process to enhance the yield. This is a secondary objective of the present invention.

The composite multi-layer circuit board and the manufacturing method thereof in the present invention uses an aluminum nitride substrate with the property similar with GaN and SiC, such as insulation (>1014 ohm-cm), high thermal conductivity (K>160 W/mK), and thermal expansion coefficient and lattice constant, and then uses the DPC thin film process to narrow the width of metal wires (<0.15 mm) and the spacing between the wires. Also, the surface of the aluminum nitride substrate undergoes the etching process to produce a micro-groove structure, and the copper wires are embedded in the interior to achieve better heat dissipation. This is another objective of the present invention.

According to the composite multi-layer circuit board and the manufacturing method thereof in the present invention, the aluminum nitride substrate is etched using Plasma. A better wiring aspect ratio could be achieved using a reactive ion gas injecting toward a ceramic substrate. This is another objective of the present invention.

According to the composite multi-layer circuit board and the manufacturing method thereof in the present invention, dry etching is used to develop a ultra-high thermal conductivity/heat dissipation aluminum nitride substrate, which is a better choice in view of wire quality or cost. This is another objective of the present invention.

The composite multi-layer circuit board and the manufacturing method thereof in the present invention uses the mask layer self-aligned method in combination with the micro-groove etching and metalized copper wire plating techniques, using techniques such as deep substrate etching, deep groove metallization, self-aligned copper plating, planarization, high thermal insulation material coating, and intertwined copper wire technique, so that the multi-layer circuit substrate metallization copper plating is completed for subsequent manufacturing of the composite multi-layer circuit board. This is a further objective of the present invention.

The composite multi-layer circuit board and the manufacturing method thereof in the present invention is plated with thin copper using the DPC metalized copper wire technique with a vacuum sputtering method of thin film process, and then completed using the photolithography process. Therefore, the width of the diameter is 10˜50 μm, and even finer. Also, the surface roughness is high (<0.3 μm), and the circuit alignment accuracy is merely +/−1%, which avoids shrinkage ratio screen net, surface roughness, high manufacturing costs and other issues, and also resolves the problem of the LTCC/HTCC sintering shrinkage ratio and halftone net of the thick film process. This is a further objective of the present invention.

The objective, shape, structure, features, and effects of the present invention will become more apparent with reference to the embodiments in conjunction with accompanying drawings, as described in detail hereinafter:

### BRIEF DESCRIPTION OF THE DRAWINGS

FIG. 1 is a schematic diagram showing a conventional configuration of two sets of color temperature circuits disposed on a substrate;

FIG. 2 is a schematic diagram showing a configuration of a composite multi-layer circuit board with the two sets of color temperature circuits according to the present invention; and

FIGS. 3A-3H are flow charts showing steps of manufacturing the composite multi-layer circuit board according to the present invention.

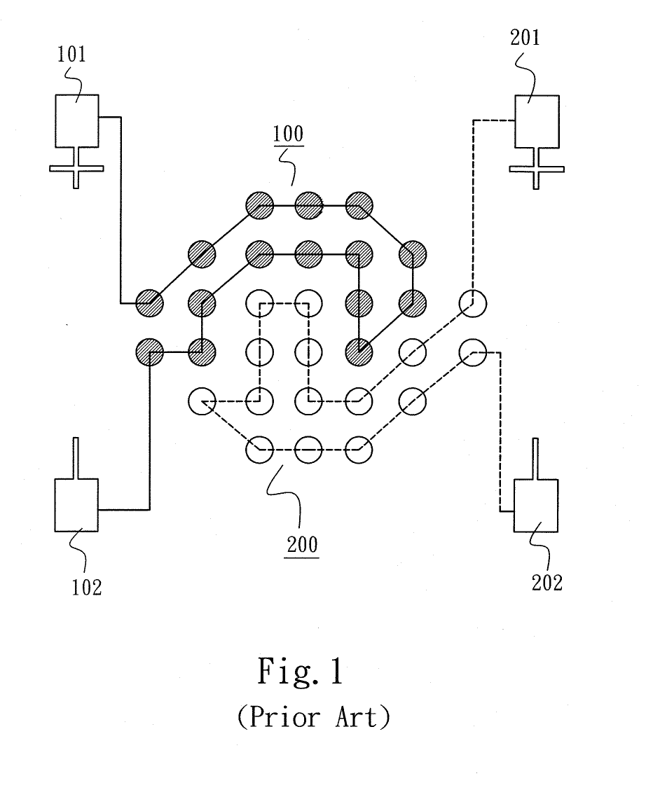

### DETAILED DESCRIPTION OF THE PREFERRED EMBODIMENT

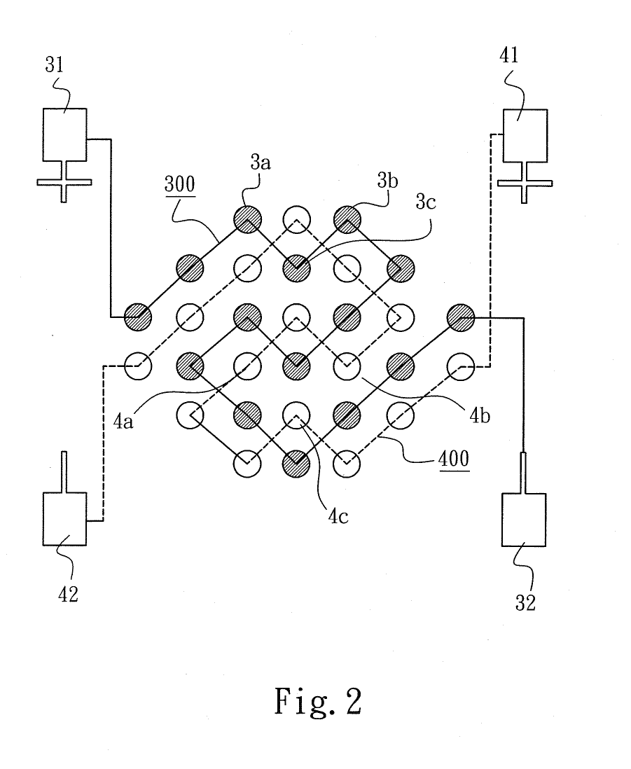

A composite multi-layer circuit board in the present invention, as shown in FIG. 2, wherein at least two sets of circuits, a first color temperature LED circuit 300 and a second color temperature LED circuit 400, are provided on a ceramic substrate for conducting different color temperature LEDs. Each of the two color temperature LED circuits 300 and 400 is connected with a cathode 31 and 41 and an anode 32 and 42 to form a single loop respectively. Also, the first color temperature LED circuit 300 and the second color temperature LED circuit 400 are intertwined with each other.

As shown in the figure, the first color temperature LED circuit 300 is connected with a plurality of first color temperature LEDs 3a, 3b, 3c . . . , and the second color temperature LED circuit 400 is connected with a plurality of second color temperature LEDs 4a, 4b, 4c . . . . Since the first color temperature LED circuit 300 and the second color temperature LED circuit 400 are intertwined with each other, part of the first color temperature LEDs 3a, 3b, 3c . . . and part of the second color temperature LEDs 4a, 4b, 4c . . . are adjacently disposed, so that the first color temperature LEDs 3a, 3b, 3c . . . and the second color temperature LEDs 4a, 4b, 4c . . . are disposed at intervals adjacently in a mixed manner.

Accordingly, when the first color temperature LEDs 3a, 3b, 3c . . . and the second color temperature LEDs 4a, 4b, 4c . . . are simultaneously illuminated, through uniformly mixed light of the first color temperature LEDs and the second color temperature LEDs, the overall distribution of the light color is more even and soft.

The method of manufacturing the composite multi-layer circuit board according to the present invention uses the mask layer self-aligned method in combination with the micro-groove etching and metalized copper wire plating techniques. Firstly, an aluminum nitride substrate is cleaned in the pre-treatment. Then, the substrate is sputtered and bonded to a copper metal composite layer using a thin-film professional manufacturing technique—vacuum coating method, and then the manufacturing of wires are completed through the photoresist coating exposure, development, etching, and stripping of the photolithography. Finally, an electroplating/chemical plating deposition method is used to increase the wire thickness. The manufacturing of metallized circuit is completed after the photoresist is removed. The manufacturing steps include:

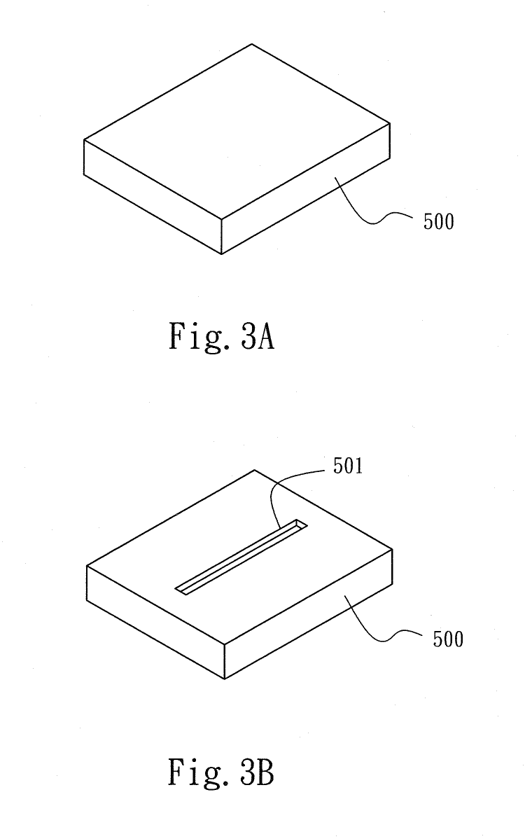

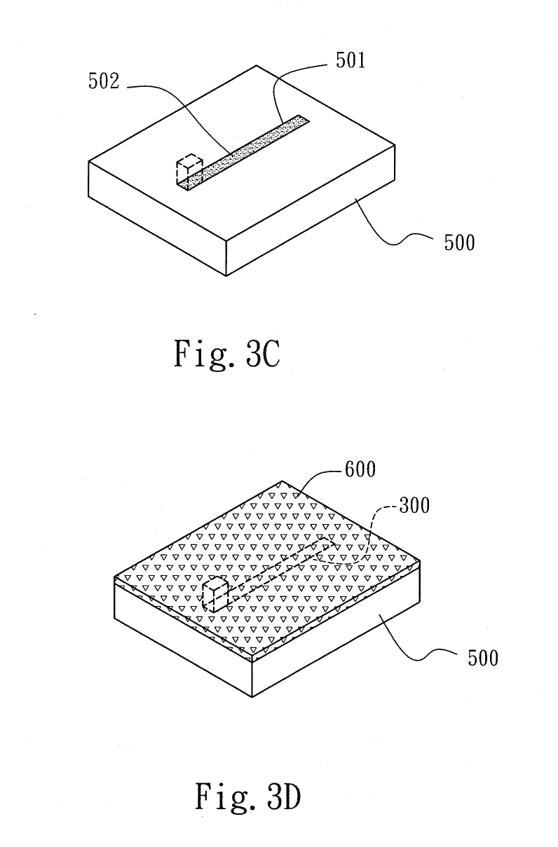

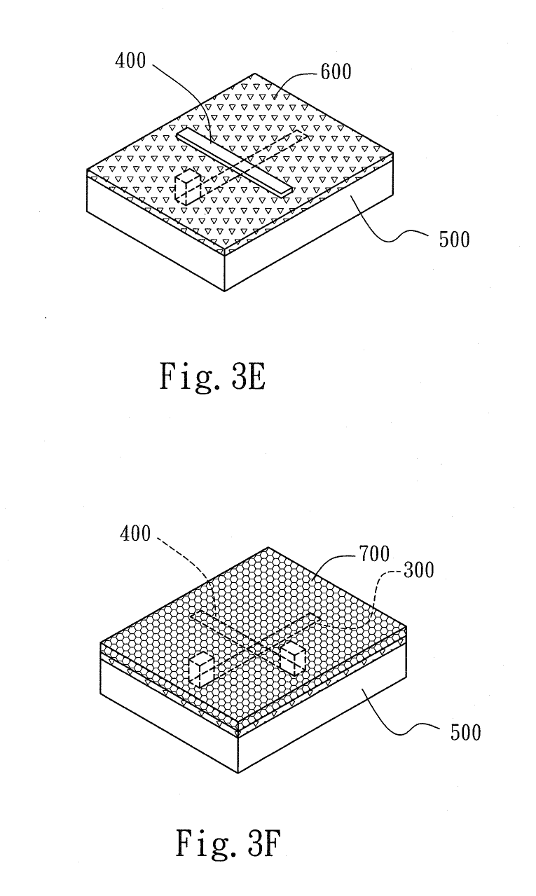

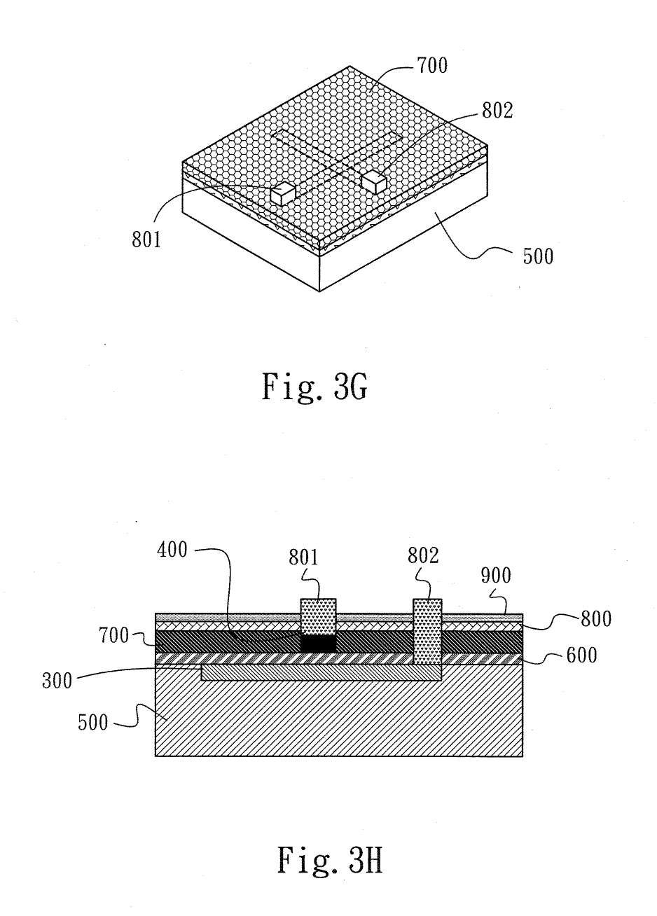

Selecting an aluminum nitride substrate 500, as shown in FIG. 3A;

Forming a linear groove 501 on the aluminum nitride substrate 500 using a deep substrate etching technique, and applying a groove metallization technique to the linear groove 501. The etching depth of the linear groove 501 is 30-50 μm, and the groove metallization thickness is 0.4-0.6 μm, as shown in FIG. 3B;

Copper plating in the linear groove 501 to form a copper wire 502 using a self-aligned copper plating technique, and then flattening the surface through a planarization technique, wherein the copper plating depth is 30-40 μm, and the planarization roughness is less than 3.0 μm; the manufacturing of the first color temperature LED circuit is completed, as shown in FIG. 3C;

Forming a high thermal conductivity insulation layer 600 that covers the first color temperature LED circuit 300 on an upper surface of the substrate 500 using a high thermal insulation material coating technique. The material for the high thermal conductivity insulation layer 600 may be aluminum oxide, and the thickness is 5-25 μm, as shown in FIG. 3D;

Then, forming a second color temperature LED circuit 400 which is intertwined with the first color temperature LED circuit 300 on the high thermal conductivity insulation layer 600 through an intertwined copper wire technique. The thickness of the second color temperature LED circuit 400 is 30-40 μm, as shown in FIG. 3E;

Then, forming a second high thermal conductivity insulation layer 700 which covers the second color temperature LED circuit 400 on the second color temperature LED circuit 400 through a high thermal insulation material coating technique. The second high thermal conductivity insulation layer 700 may be aluminum oxide, and its thickness is 35-65 μm, as shown in FIG. 3F;

Finally, coating a Nickel silver reflective layer 800 on the surface of the second high thermal conductivity insulation layer 700 using a highly reflective metal coating technology. The thickness of the Nickel silver reflective layer 800 is 0.19-2.01 μm. An aluminum oxide protective layer 900 is formed above the Nickel silver reflective layer 800. The thickness of the aluminum oxide protective layer is 125 μm. Finally, producing bond pads 801, 802 using a self-aligned eutectic bond pad technique, as shown in FIGS. 3G and 3H.

In the composite multi-layer circuit board and the manufacturing method thereof according to the present invention, one of the first color temperature LED circuit and the second color temperature LED circuit is embedded in the interior of the substrate surface, and another circuit is then formed on the substrate surface, so that different color temperature LEDs can be disposed adjacently and collocated in a mixed manner, so that the overall emitted light becomes more even and soft. Certainly, the present approach can be used for a multi-layer color temperature LED circuit to form on a substrate.

As described above, the composite multi-layer circuit board and a manufacturing method thereof according to the present invention has an unprecedented innovative structure, which is not found in any publication. Also, there are no similar products in the market. Therefore, the composite multi-layer circuit board possesses novelty undoubtedly. In addition, the present invention has unique features and functionality far from the others in the art. It is indeed more inventive than the others in the art, and meets the requirements of the application requirements of the new patent law. Accordingly, the patent application has been filed in accordance with patent law.

The described embodiments are only for illustrative and exemplary, not limited thereto. Certain changes and modifications without departing from the spirit and scope of the invention shall be encompassed within the accompanying claims.

What is claimed is:

1. A composite multi-layer circuit board, on which at least two sets of circuits are disposed on a ceramic substrate for connecting to a first color temperature LED group and a second color temperature LED group; each of the two circuits is connected to a cathode and an anode to form a single loop respectively; wherein the two sets of circuits are intertwined with each other, and the first color temperature LEDs and the second color temperature LEDs are disposed at intervals adjacently.

2. The composite multi-layer circuit board as claimed in claim 1, wherein the two sets of circuits are a first color temperature LED circuit and a second color temperature LED circuit, the first color temperature LED circuit and the second color temperature LED circuit are intertwined with each other; also, one of the first color temperature LED circuit or the second color temperature LED circuit is embedded into the interior of the substrate surface.

3. The composite multi-layer circuit board as claimed in claim 1, wherein a Nickel silver reflective layer having a high reflection property is formed above the upper circuit, and an aluminum oxide protective layer covering the Nickel silver reflective layer is formed.

4. The composite multi-layer circuit board as claimed in claim 3, wherein the thickness of the Nickel silver reflective layer is 0.19-2.01 μm, and the thickness of the aluminum oxide protective layer is 125 μm.

5. A method of manufacturing the composite multi-layer circuit board as claimed in claim 1, comprising the following steps:
selecting an aluminum nitride substrate;
forming a linear groove on the aluminum nitride substrate using a deep substrate etching technique, and applying a groove metallization technique to the linear groove;
copper plating in the linear groove to form a copper wire using a self-aligned copper plating technique, and then flattening the surface using a planarization technique;
forming a high thermal conductivity insulation layer that covers the first color temperature LED circuit on the upper surface of the substrate using a high thermal insulation material coating technique;
manufacturing a second color temperature LED circuit that is intertwined with the first color temperature LED circuit on the high thermal conductivity insulation layer using an intertwined copper wire technique;
forming a second high thermal conductivity insulation layer above the second color temperature LED circuit that covers the second color temperature LED circuit using a high thermal insulation material coating technique; and
a solver layer is plated on the surface of the second high thermal conductivity insulation layer using a highly reflective metal layer plating technique, and bond pads are manufactured using a self-aligned eutectic bond pad technique.

6. The method of manufacturing the composite multi-layer circuit board as claimed in claim 5, wherein the etching depth of the substrate surface is 30-50 μm; the groove metallization thickness is 0.4-0.6 μm; copper plating depth is 30-40 μm; the roughness of planarization technique is less than 3.0 μm; the thickness of a high thermal conductivity insulation layer is 5-25 μm; the thickness of a second color temperature circuit is 30-40 μm; the thickness of a second high thermal conductivity insulation layer is 35-65 μm; the thickness of a reflective layer is 0.19-2.01 μm.
